(19) United States
(12) Patent Application Publication
(10) Pub. No.: US 2008/0062300 A1
(43) Pub. Date: Mar. 13, 2008

(54) ELECTRONIC DEVICE AND IMAGE-SENSING DEVICE THEREOF

(75) Inventor: PO-SUNG HU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,014

(22) Filed: Dec. 22, 2006

(30) Foreign Application Priority Data
Sep. 8, 2006 (CN) 200610062516.4

(51) Int. Cl. H04N 5/225

(52) U.S. Cl. 348/340

(57) ABSTRACT

An electronic device includes a monitor (90) including a screen (91), and an image-sensing device (80) disposed on the screen. The image-sensing device includes a first plate (10), a second plate (20) opposite to the first plate, and at least one image-sensing element (30) disposed between the first plate and the second plate. The image-sensing element includes a lens (32), a holder (34) for holding the lens, an image sensor (38) for sensing light from the lens and generating an image signal. The image sensor is disposed opposite to the lens.

### BACKGROUND OF THE INVENTION

1. Field of the Invention

The present invention pertains to image-sensing devices, and particularly to an electronic device comprising an image-sensing device.

2. Description of Related Art

Electronic devices, such as cell phones, personal digital assistants (PDAs), and notebook computers, need an image-sensing device to support video communication.

A conventional approach utilizes an independent image-sensing device, especially a digital camera. The camera is usually disposed adjacent to a monitor of the electronic device. However, users may only directly face either the monitor or the camera, thus eye contact cannot be established between the users, which is undesirable. Besides, although some conventional designs have included image sensors in the monitor so that the users can easily establish eye contact when they use the monitor and the image sensors as the camera at the same time, these image sensors are usually disposed beside the display pixels of the monitor and therefore the monitor becomes complicated and difficult to be made, no matter the mechanical part or the electrical part of the monitor.

Therefore, a heretofore unaddressed need exists in the industry to overcome the aforementioned deficiencies and inadequacies.

### SUMMARY OF THE INVENTION

In an exemplary embodiment, an electronic device or a display device includes a monitor including a display screen, and an image-sensing device disposed on the screen. The image-sensing device includes a first plate, a second plate opposite to the first plate, and at least one image-sensing element disposed between the first plate and the second plate. The image-sensing element includes a lens, a holder for holding the lens, an image sensor for sensing light from the lens and generating an image signal. The image sensor is disposed opposite to the lens.

Other advantages and novel features will become more apparent from the following detailed description of preferred embodiments when taken in conjunction with the accompanying drawings, in which:

### BRIEF DESCRIPTION OF THE DRAWINGS

FIG. 1 is a plan view of an image-sensing device of an exemplary embodiment of the present invention;

FIG. 2 is an enlarged, cut-away side view of an image-sensing element of FIG. 1;

FIG. 3a is a schematic diagram of the image-sensing device being pre-assembled with a screen of a monitor;

FIG. 3b is a schematic diagram of the image-sensing device being assembled with a screen of a monitor;

FIG. 4 is a schematic diagram of a layout of circuits in the image-sensing device;

FIG. 5 is an enlarged, cut-away side view of the image-sensing device of another exemplary embodiment; and

FIG. 6 is a schematic diagram of a layout of circuits in the image-sensing device of FIG. 5.

### DETAILED DESCRIPTION OF THE INVENTION

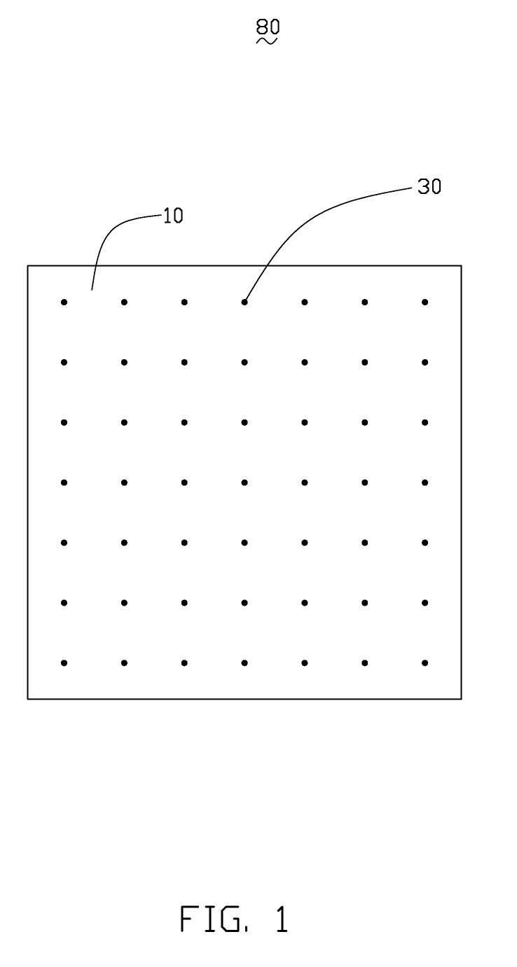

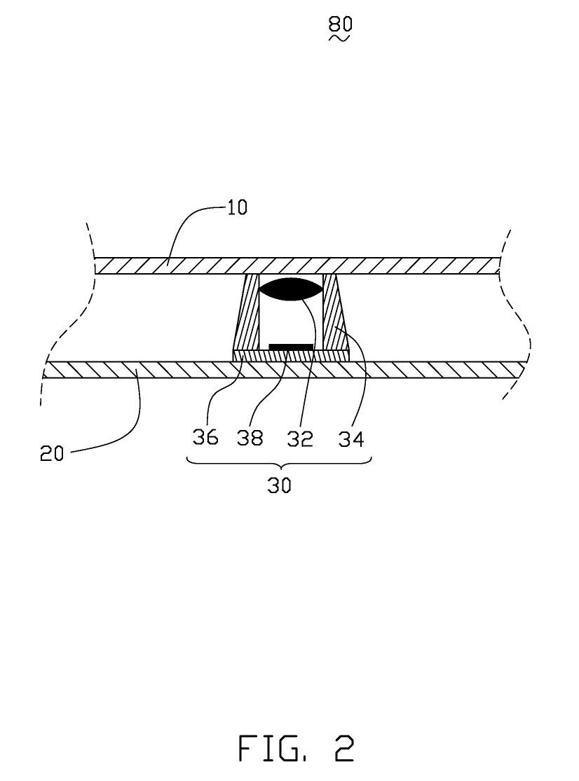

Referring to FIGS. 1 and 2, an image-sensing device 80 of an electronic device like a display device of an exemplary embodiment of the present invention comprises a first plate 10, a second plate 20 opposite to the first plate 10, and a plurality of image-sensing elements 30 arranged between the first plate 10 and the second plate 20 in an array. FIG. 1 shows forty-nine image-sensing elements 30. While the number of image-sensing elements 30 is designated in FIG. 1, it should be understood that the number of the image-sensing elements 30 is presented by way of example only and not by way of limitation.

The image-sensing element 30 comprises a lens 32, a holder 34, a bottom plate 36, and an image sensor 38. The holder 34 is secured to the first plate 10 and the bottom plate 36 by adhesive. The lens 32 is used for focusing light on the image sensor 38 and is held by the holder 34. The image sensor 38 is disposed on the bottom plate 36 and is opposite to the lens 32. The bottom plate 36 is disposed on the second plate 20. The image sensor 38 is used for sensing light from the lens 32 and generating an image signal.

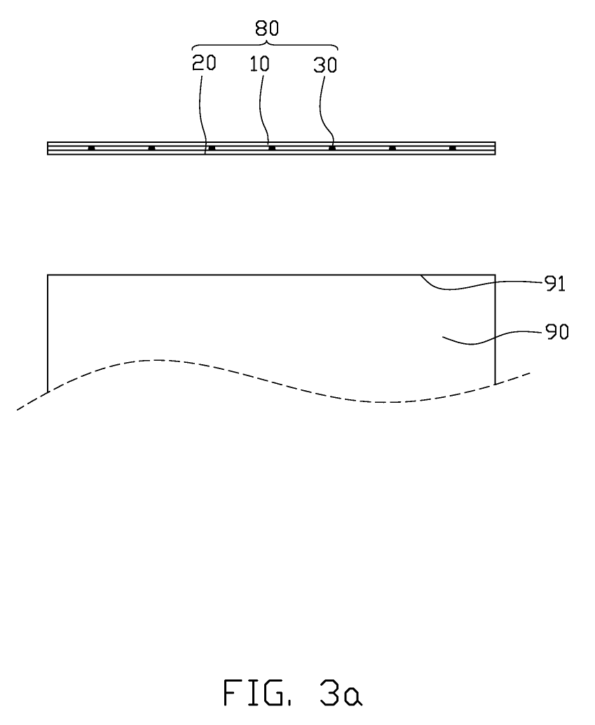

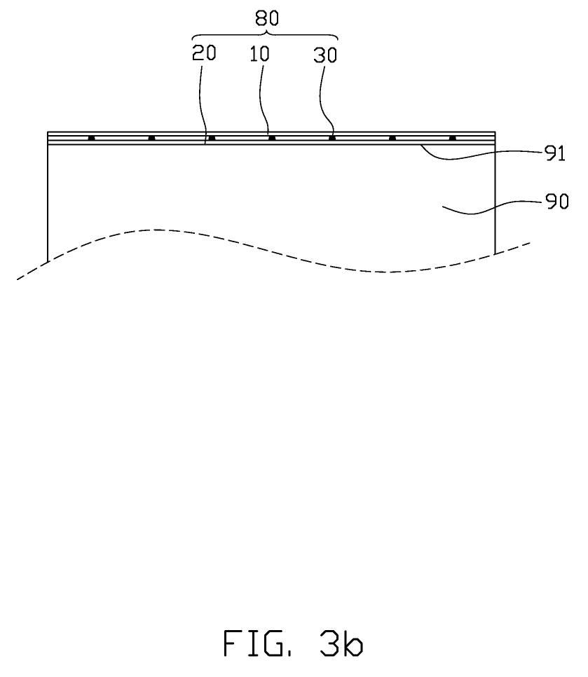

Referring also to FIG. 3a and FIG. 3b, in assembly, the image-sensing device 80 is disposed on a display screen 91 of a monitor 90 of the display device. The second plate 20 is adjacent to the screen 91. The monitor 90 can be a stand-alone product, or a part of an electronic device such as a cell phone, a personal digital assistant (PDA), a computer, a television and so on. Note that the first plate 10 or the second plate 20 can be the screen 91 of the monitor 90. The first plate 10 and the second plate 20 are made of transparent material. Exemplary materials for the first plate 10 and the second plate 20 comprise PC (polycarbonate), ABS (Acrylonitrile Butadiene Styrene), silicon-compound and so on. However, any other material or combination of materials providing a like function as disclosed herein may alternatively be employed. In the exemplary embodiment, the first plate 10 and the second plate 20 are made of a silicon-compound.

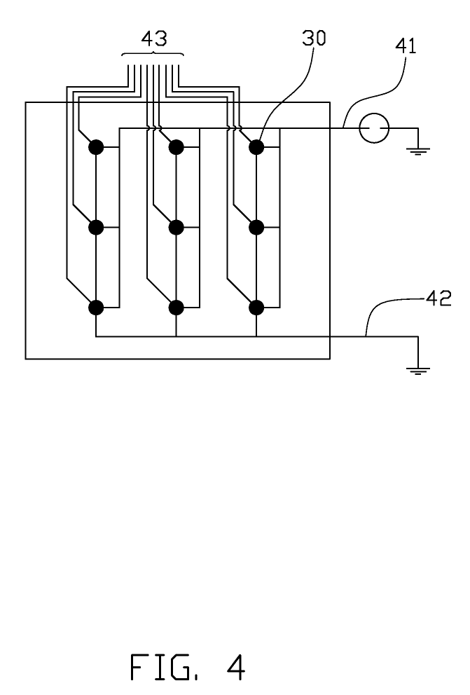

Referring also to FIG. 4, it illustrates layout of circuits in the image-sensing device 80. FIG. 4 shows nine image-sensing elements 30 as an example. The image-sensing device 80 further comprises a plurality of electrically conductive lines connected to the image sensors 38 of the image-sensing elements 30. The conductive lines comprise a plurality of signal lines 43, a plurality of power lines 41, and a plurality of ground lines 42. The power lines 41 are used for supplying power to the image sensor 30. The signal lines 43 are used for transmitting the image signals generated by the image sensor 38 of the image-sensing elements 30.

During use, the image sensor 38 of each image-sensing element 30 senses the light from the lens 32 and generates a plurality of signals. The signals are processed by a processor (not shown) into an appropriate format for color adjustment and for combining with the other signals of all the image-sensing elements 30 into a unified image, which can then be processed for transmission via a network such as the Internet.

With the image-sensing device 80 being disposed on the screen 91 of the monitor 90 of an electronic device, a user can comfortably face the screen 91 and any other user viewing the image picked up by the image-sensing device 80 will see a direct view of the user's face, which is beneficial to communication. In addition, with the image-sensing device 80 being separable from the monitor 90, the image-sensing device 80 can be mounted to various other monitors 90, thus providing a very useful portable function.

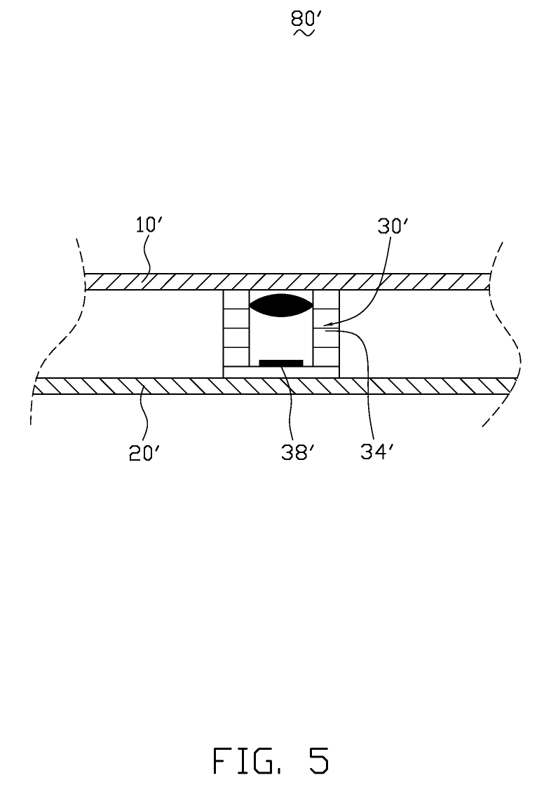

Referring to FIG. 5, it illustrates the image-sensing device 80′ of another exemplary embodiment. In this exemplary embodiment, the holder 34′ is a multi-layer substrate. The substrate comprises a plurality of electrically conductive lines disposed therein. The conductive lines are electrically connected to the image sensor 38′ by vias defined in the substrate.

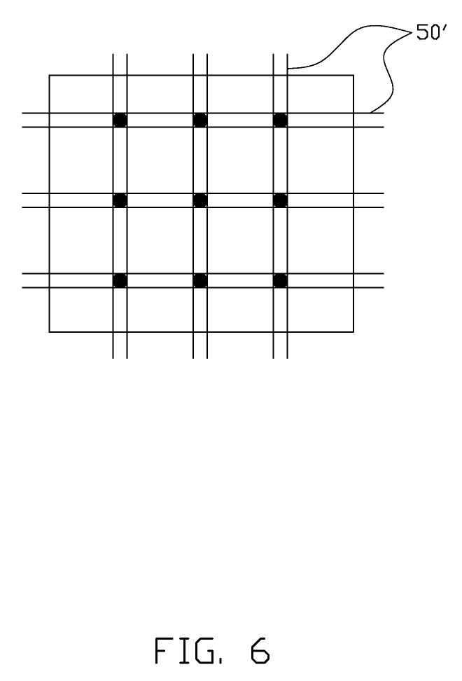

Referring also to FIG. 6, it illustrates a layout of circuits in the image-sensing device of FIG. 5. The conductive lines in the substrate are electrically connected to a plurality of transmission lines 50′. The transmission lines 50′ are for transmitting the image generated by the image sensor 38′, and supplying power to the image sensor 38′. The transmission lines 50′ are arranged cross-wise between the first plate 10′ and the second plate 20′, and are stacked along a direction perpendicular to the first plate 10′ and the second plate 20′, thus increasing transparency of the image-sensing device 80′ to facilitate customer-use.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An image-sensing device, comprising:
a first plate;
a second plate opposite to the first plate; and
at least one image-sensing element disposed between the first plate and the second plate, the image-sensing element comprising:
a lens;
a holder for holding the lens; and
an image sensor for sensing light from the lens and generating an image signal, the image sensor opposite to the lens.

2. The image-sensing device as claimed in claim 1, wherein the image-sensing element further comprises a bottom plate disposed on the second plate.

3. The image-sensing device as claimed in claim 2, wherein the image sensor is disposed on the bottom plate.

4. The image-sensing device as claimed in claim 2, wherein the holder is secured to the first plate and the bottom plate by adhesive.

5. The image-sensing device as claimed in claim 1, wherein the first plate and the second plate are made of transparent material.

6. The image-sensing device as claimed in claim 1, wherein the holder is made of a multi-layer material.

7. The image-sensing device as claimed in claim 1, further comprising a plurality of signal lines for transmitting the image signal generated by the image sensor, a plurality of power lines for supplying power to the image sensor, and a plurality of ground lines, the signal lines, the power lines, and the ground lines are electrically connected to the image sensors.

8. An electronic device, comprising:
a monitor comprising a display screen; and
an image-sensing device disposed on the screen, comprising:
a first plate;
a second plate opposite to the first plate; and
at least one image-sensing element disposed between the first plate and the second plate, the image-sensing element comprising:
a lens;
a holder for holding the lens; and
an image sensor for sensing light from the lens and generating an image signal, the image sensor opposite to the lens.

9. The electronic device as claimed in claim 8, wherein the image-sensing element further comprises a bottom plate disposed on the second plate.

10. The electronic device as claimed in claim 9, wherein the image sensor is disposed on the bottom plate.

11. The electronic device as claimed in claim 9, wherein the holder is secured to the first plate and the bottom plate by adhesive.

12. The electronic device as claimed in claim 8, wherein the first plate and the second plate are made of transparent material.

13. The electronic device as claimed in claim 8, wherein the holder is made of a multi-layer material.

14. The electronic device as claimed in claim 8, further comprising a plurality of signal lines for transmitting the image signal generated by the image sensor, a plurality of power lines for supplying power to the image sensor, and a plurality of ground lines, the signal lines, the power lines, and the ground lines are electrically connected to the image sensors.

15. A display device comprising:
a monitor comprising a display screen defined along a first plane; and
an image-sensing device extending along a second plane neighboring said first plane so as to be disposed beside said display screen, said image-sensing device comprising a plurality of image-sensing elements dispersing throughout said image-sensing device so that a dispersing area of said plurality of image-sensing elements covers partially said display screen.

16. The display device as claimed in claim 15, wherein said plurality of image-sensing elements are disposed between a first plate and a second plate, which are made of transparent material, of said image-sensing device.
